(19) United States
(12) Patent Application Publication
(10) Pub. No.: US 2010/0134522 A1
(43) Pub. Date: Jun. 3, 2010

(54) LIQUID CRYSTAL DISPLAY COMPRISING A SCANNING BACKLIGHT

(75) Inventor: Alexander Christiaan De Rijck, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,240

(22) PCT Filed: Aug. 1, 2006
(86) PCT No.: PCT/IB06/52630

§ 371 Date: Feb. 8, 2008

(30) Foreign Application Priority Data
Aug. 9, 2005 (EP) 05107308.8

(51) Int. Cl. G09G 5/10; G09G 3/36

(52) U.S. Cl. 345/690; 345/102

(57) ABSTRACT

A scanning backlight (23) to illuminate a liquid display panel (21) comprising multiple light sources (231) arranged in rows of light sources and columns of light sources, and a backlight driver (24) comprising at least one row driver (24a) to drive the rows of light sources and at least two column driver banks (24c) to drive the columns of light sources, wherein each column driver bank (24c) drives at least two of the columns of light sources simultaneously.

The invention relates to a device comprising a liquid crystal display (LCD-display), and also relates to a liquid crystal display, to a scanning backlight and to a scanning backlight driver.

Examples of such a device are televisions, monitors, vehicle equipment, craft equipment, plane equipment, laptop equipment such as personal computers and handheld equipment such as still picture cameras, motion video cameras and mobile phones. LCD-display suffer from a so-called blur phenemenon (motion artifact) in which a pictures screen becomes cloudy when displaying a moving picture due to a slow response characteristic and a sustaining characteristic of the liquid crystal even when a response speed of the liquid crystal is faster than one frame interval. At this moment most LCD-display backlight consist of fluorescent lamps. A new development is a LED-backlight.

Document US 2005/0007516 A1 discloses a liquid crystal display panel having liquid crystal cells (so-called pixels) arranged in a matrix, a scanning backlight comprising an array of light emitting diodes (LED) and a liquid crystal display driver to drive the array of LEDs to illuminate the liquid crystal display cells (pixels). To prevent the blur phenomenon, the the LED array is driven in a scanning backlight mode where the LEDs are sequentially driven (turning on and off) in the scanning direction of the video signal applied to the LCD-display to emit light at an initial time of one frame interval while shutting off the light in the remaining time intervall. Accordingly, the scanning backlight mode prevents the blur phenomenon by eliminating the influence of the previous display pixel on the next display pixel.

However, the use of a scanning backlight reduces the overall light output of the backlight. The LEDs will only emit light during a short period in contrast to non-scanning backlights, where the LEDs are continously on.

It is an object of the invention, to provide a scanning backlight and a LCD-display with a scanning backlight with improved brightness.

The object is solved by a scanning backlight to illuminate a liquid display panel comprising multiple light sources arranged in rows of light sources and columns of light sources, and a backlight driver comprising at least one row driver to drive the rows of light sources and at least two column driver banks to drive the columns of light sources, wherein each column driver bank drives at least two of the columns of light sources simultaneously. Here the terms “rows” and “columns” denote two different geometrical directions within an arrangement of light sources to drive the connected light sources. Both terms do not imply any special alignment between light sources arranged in rows in relation to light sources arranged in columns, e.g. rows and columns are not neccesarily vertically aligned to each other. However, one example of such an arrangement may be an array of light sources with vertically aligned rows and columns.

In case of the liquid crystal display panel being driven row after row, the specific liquid crystal display panel pixels comprises a row. The corresponding light sources within the scanning backlight might then correspond with the corresponding row of the liquid crystal display panel and might then further for example comprise a previous row and a next row of the scanning backlight. This corresponds with driving the scanning backlight one row ahead and three times as long compared to the driving of the liquid crystal display panel. In other words, the driving of the liquid crystal display panel is overlapped by the driving of the scanning backlight in time and place. Driving more columns simultaneously will even increase the brightness by still maintaining the prevention of the blur phenomenon. For instance, driving at least two columns simultaneously will result in a doubled brightness per video frame. However, there is an upper limit of the number of parallel driven columns to keep occurance of the blur phenomenon neglectable

In another embodiment the scanning backlight driver further comprises an individualizing backlight driver for driving each light source separately for individualizing the illumination intensity locally. This embodiment for example comprises the driving of the light sources in an individualized way such that a specific part of the liquid crystal display panel is given a specific intensity by driving a corresponding part of the array of the light sources accordingly. As a result, the liquid crystal display panel may obtain an amended local contrast, such as an improved local contrast, for example based on information originating from a video signal to be displayed by still maintaining the prevention of the blur phenomenon at higher overall brightness. A part of the light sources thereby for example corresponds with at least a part of one or more rows of the liquid crystal display panel and/or with at least a part of one or more columns of the liquid crystal display panel and may have, compared to a liquid crystal display panel pixel, for example a similar size or a larger size. The individualizing backlight driver may comprise a column timer to drive each column of one column driver bank separately.

In another embodiment the light sources of the scanning backlight are inorganic or organic LEDs or laser diodes. These light sources are small light sources (in case of inorganic LEDs) or can be segmented into a number of small light sources by appropriate production techniques. Small light sources are required to illuminate a LCD-panel locally. Laser diodes can be arranged in a similar way like inorganic LEDs, eventually applying waveguides coupled to the laser diodes. These light sources are available as white light sources or colored light sources.

This invention further relates to a liquid crystal display comprising a liquid crystal display panel and a backlight as claimed in claim 1. If the scanning backlight is an integral part of the liquid crystal display, the liquid crystal display is most compact.

In another embodiment the backlight is disconnectable from the liquid crystal display. A disconnectable backlight can easily be exchanged, e.g. in case of malfunctions.

In another embodiment the backlight of the liquid crystal display is modulated according to a video information signal applied to the liquid crystal display panel. With this feature, the backlight for instance can be operated to emit light with a higher brightness in lighter scenes and is dimmed in darker scenes. In this way a contrast improvement is achieved.

The invention further relates to a driving method to drive a scanning backlight as claimed in claim 1 comprising the steps:
modulating the rows of light sources of the scanning backlight according to a video information signal applied to a liquid crystal display, and
driving at least two columns of light sources simultaneously for each column driver bank.

These and other aspects of the invention will be apparent from and elucidated with reference to the embodiments of the liquid crystal display according to the invention and of the backlight according to the invention and of the backlight driver according to the invention and of the method according to the invention described hereinafter.

In the drawings:

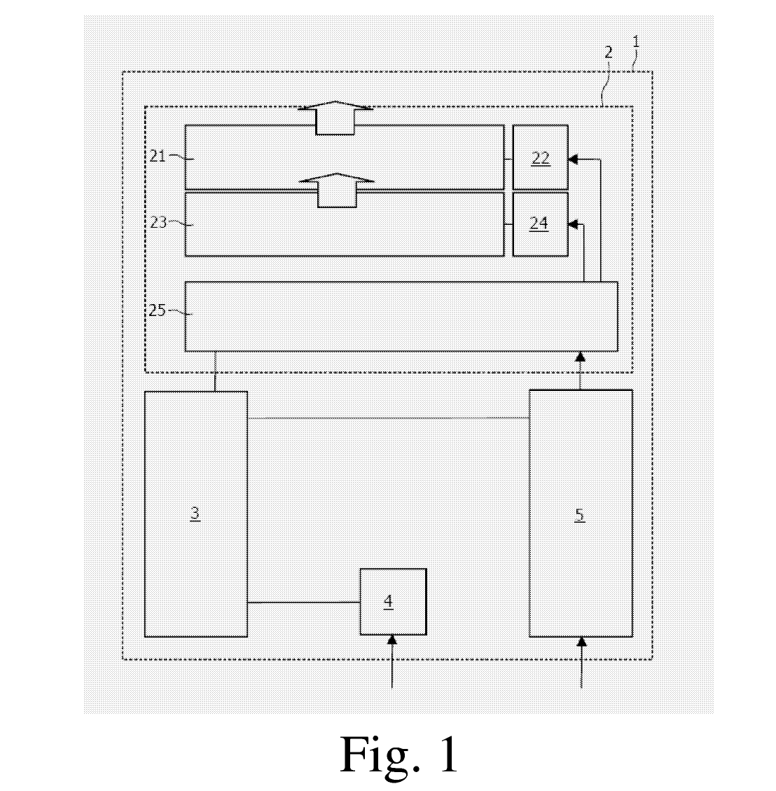

FIG. 1: shows diagrammatically a device according to the invention comprising a liquid crystal display according to the invention with an scanning backlight according to the invention and a backlight driver according to the invention,

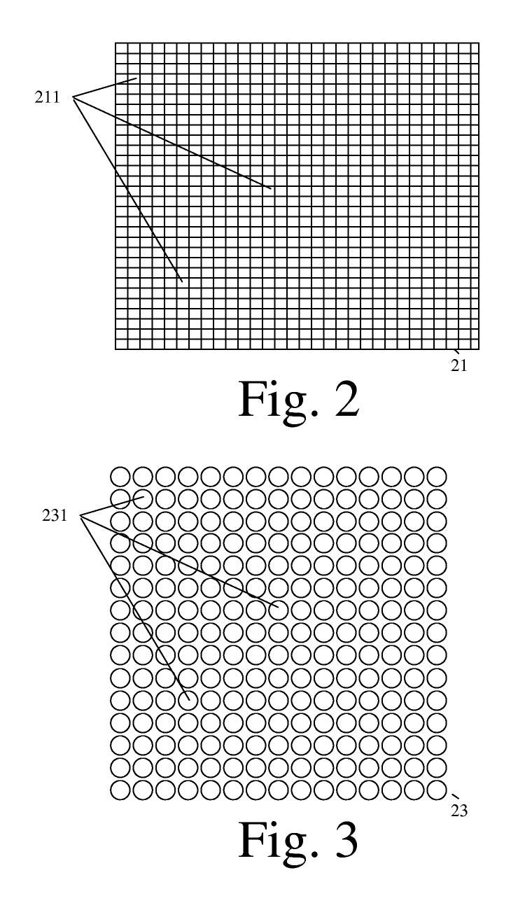

FIG. 2: shows diagrammatically a liquid crystal display panel,

FIG. 3: shows diagrammatically an arrangement of light sources of the scanning backlight according to the invention,

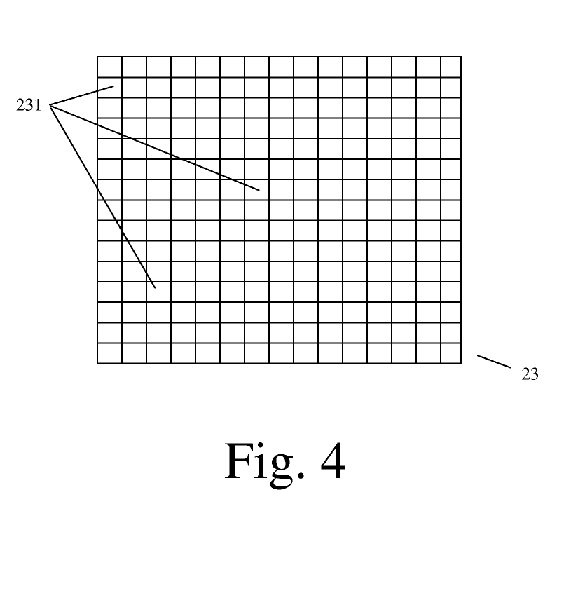

FIG. 4: shows diagrammatically another arrangement of light sources of the scanning backlight according to the invention, and

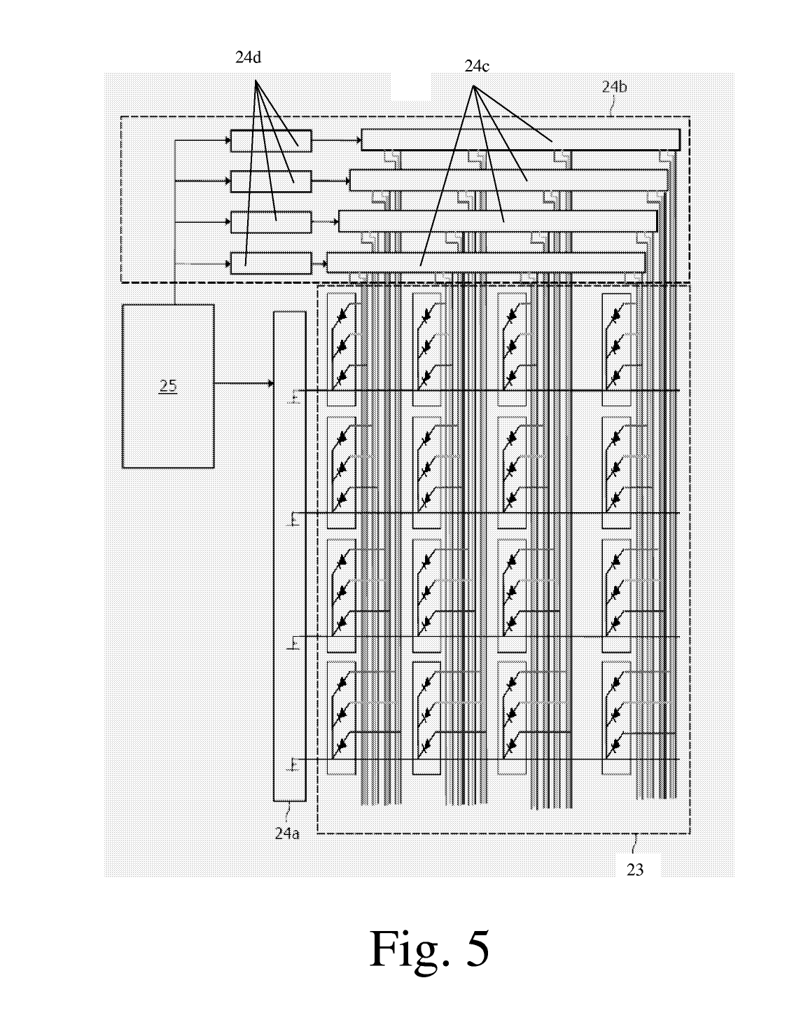

FIG. 5: shows diagrammatically a scanning backlight driver according to the invention coupled to a scanning backlight.

The device 1 according to the invention shown in FIG. 1 comprises a liquid crystal display 2 according to the invention. The liquid crystal display 2 comprises a prior art liquid crystal display panel 21 (side view), a scanning backlight 23 comprising multiple light sources arranged in rows and columns of light sources, and a backlight driver 24 according to the invention for driving the light sources of the scanning backlight 23. The liquid crystal display 2 further comprises a prior art liquid crystal display driver 22 and a controller 25 coupled to both drivers 22 and 24. Each one of the drivers 22 and 24 may for example comprise one or more row drivers and one or more column drivers, in case of the backlight driver two or more column driver banks. The device 1 further comprises a processor 3 coupled to an interface 4 and to a receiver 5. The interface 4 for example receives signals from a user and for example comprises an infrared receiver or a keyboard or a mouse. The receiver 5 receives a video signal to be displayed via the liquid crystal display panel 21 and is thereto further coupled to the controller 25.

The liquid crystal display panel 21 shown in FIG. 2 (in top view) for example comprises liquid crystal cells 211 (or pixels) of 30 rows and 30 columns. The scanning backlight 23 shown in FIG. 3 (in top view) for example comprises 225 LED light sources 231 (15 rows and 15 columns). An alternative scanning backlight 23 is shown in FIG. 4 (in top view) comprising for example 225 segmented organic LED light sources 231 (15 rows and 15 columns).

The backlight driver 24 comprises a scanning backlight driver for driving the scanning backlight 23 in a scanned way for reducing a blur phenomenon of the liquid crystal display panel 21. The scanning backlight driver for example drives the light sources 231 of the scanning backlight 23 in a sequential way and/or in accordance with a scanning direction of the liquid crystal display panel 21. A light source 231 of the scanning backlight 23 thereby for example corresponds with one cross point of one row and one column of the liquid crystal display panel 21 or with two or more cross points of the liquid crystal display panel 21. In FIGS. 2, 3 and 4, in case the liquid crystal display panel 21 is driven row by row, the light sources of the scanning backlight 23 are driven row by row, in this case at half the speed or at double duration of the driving of the liquid crystal display panel 21, owing to the fact that the liquid crystal display panel 21 comprises twice as many rows and columns than there are segment rows and segment columns.

The backlight driver 24 may comprise a scanning and individualizing backlight driver for driving the light sources of the scanning backlight 23 in a scanned and individualized way for reducing a blur phenomenon of the liquid crystal display panel 21 and for individualizing intensities of liquid crystal display panel segments. In case of the liquid crystal display panel 21 being driven row after row, the corresponding light sources of the scanning backlight 23 might then for example correspond with the corresponding row of the liquid crystal display panel 21 and might then further for example comprise a previous row of light sources and a next row of light sources of the scanning backlight 23. This corresponds with driving the scanning backlight 23 one line (her a row) ahead and three times as long compared to the driving of the liquid crystal display panel 21. In an alternative embodiment, driving along rows may be replaced by driving along columns.

In other words, the latter embodiment defines that the driving of the liquid crystal display panel 21 is overlapped by the driving of the scanning backlight 23 in time and place. In view of FIG. 5, this happens as follows.

In a background situation, most liquid crystal display backlights consist of fluorescent lamps. A new development is an LED backlight. The light emitting diode backlights for liquid crystal display currently on the market just generate light just like the fluorescent lamp backlights and do not have a scanning feature. Scanning is desirable because it reduces motion artifacts. Another desirable feature is local highlighting or local dimming. In this case the backlight is modulated according to the video information on the liquid crystal display-display. The backlight burns brighter in lighter scenes and is dimmed in darker scenes. In this way a contrast improvement is reached.

When a scanning backlight 23 is used, the motion artifacts will be greatly reduced but the light output will also be reduced, because the light sources 231 will no longer be continuously on. To increase the light output of a scanning backlight 23, more lines are turned on simultaneously. Instead of a scanning line (here for example a column), a scanning band (here for example a column band) is used in the scanning backlight 23. To do this, every column of light sources has multiple column drivers to ensure that each light source can still be addressed separately. In this way the advantages of scanning on the motion artifacts is maintained, local dimming of each and every light emitting diode is still ensured and the light output of the backlight will increase with respect to the same backlight without multi column drivers.

The scanning backlight comprises an arrangement of light sources 231 (for instance in an array or matrix) with rows and columns as shown in FIG. 4. Each crossing of a row and a column has a light source 231, e.g. a light emitting diode, connected. For instance, red-green-blue light emitting diodes 231 are used, but white or any other color light emitting diodes can also be used. The example here is implemented with four column driver banks 24c with four column drivers per column of light sources 231, but is valid for any number of column drivers. The first column driver bank 24c is connected to the light sources 231 on row 1, 5, 9, etc. The second column driver bank 24c is connected to the light sources 231 on row 2, 6, 10, etc. The third column driver bank 24c is connected to the light sources 231 on row 3, 7, 11, etc. The fourth column driver bank 24c is connected to the light sources 231 on row 4, 8, 12, etc. Each separate column driver bank 24c has per column a separate column timer 24d with which each individual column can be driven with a pulse width modulation signal to ensure that each individual light sources in an arrangement (here for example a matrix of light sources) can have its own driver signal and thus its own brightness.

The driving sequence is for example as follows:
Row 1 is turned on for the first line time and remains on for four line times.
Row 2 is turned on for the second line time and remains on for four line times.
Row 3 is turned on for the third line time and remains on for four line times.
Row 4 is turned on for the fourth line time and remains on for four line times.
Row 5 is turned on for the fifth line time after row 1 is switched off and remains on for four line times.
Row 6 is turned on for the sixth line time after row 2 is switched off and remains on for four line times.
Row 7 is turned on for the seventh line time after row 3 is switched off and remains on for four line times.
Row 8 is turned on for the eighth line time after row 4 is switched off and remains on for four line times, etc.

In this example, lines corresponds to rows. In alternative embodiments, line may corresponds to columns.

When a row is active the brightness of the light sources on that row is controlled by the respective column drivers by means of a pulse width modulation signal. The pulse width modulation signal must correspond to the brightness that is to be reached in four line times. The example is given for four column drivers per light source but can be scaled to any number. The number of column drivers per light source scales linearly with the number of rows that must be on simultaneously. The same principle will be applied in case of segmented organic light emitting diodes or an array of laser diodes.

The scanning backlight 23 may be an integral part of the liquid crystal display 2 or may be disconnectable from the liquid crystal display 2. Each segment may be a real segment or may be an imaginary segment. The processor 3 may comprise or may be coupled to a medium not shown for storing a computer program product to be run via the processor 3, which computer program product comprises the functions of improving a performance of a liquid crystal display panel 21 via a scanning backlight 23, and driving the light sources of the scanning backlight 23 via a backlight driver 24.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A scanning backlight (23) to illuminate a liquid display panel (21) comprising multiple light sources (231) arranged in rows of light sources and columns of light sources, and a backlight driver (24) comprising at least one row driver (24a) to drive the rows of light sources and at least two column driver banks (24c) to drive the columns of light sources, wherein each column driver bank (24c) drives at least two of the columns of light sources simultaneously.

2. The scanning backlight (23) as claimed in claim 1, characterised in that the backlight driver (24) further comprises an individualizing backlight driver (24d) for driving each light source (231) separately for individualizing the illumination intensity locally.

3. The scanning backlight as claimed in claim 2, characterised in that the individualizing backlight driver (24d) comprises a driver bank timer.

4. The scanning backlight as claimed in any of claim 1, characterised in that the light sources (231) are inorganic LEDs or organic LEDs or laser diodes.

5. A liquid crystal display (2) comprising a liquid crystal display panel (21) and a scanning backlight (23) as claimed in claim 1.

6. The liquid crystal display (2) as claimed in claim 5, characterised in that the scanning backlight (23) is disconnectable from the liquid crystal display (2).

7. The liquid crystal display (2) as claimed in claim 5, characterised in that the scanning backlight (23) is modulated according to a video information signal applied to the liquid crystal display panel (21).

8. A driving method to drive a scanning backlight (23) as claimed in claim 1 comprising the steps:
modulating the rows of light sources (231) of the scanning backlight (23) according to a video information signal applied to a liquid crystal display (21), and
driving at least two columns of light sources (231) simultaneously for each column driver bank (24c).
